(19) United States
(12) Patent Application Publication
(10) Pub. No.: US 2019/0317529 A1
(43) Pub. Date: Oct. 17, 2019

(54) VIRTUAL FORCE SYSTEM FOR A DRONE

(71) Applicant: TEAL DRONES, INC., Salt Lake City, UT (US)

(72) Inventors: George Michael Matus, Salt Lake City, UT (US); Braden Stuart Scothern, West Valley City, UT (US); Matthew Lund Stoker, Bountiful, UT (US)

(21) Appl. No.: 16/380,317

(22) Filed: Apr. 10, 2019

Related U.S. Application Data
(60) Provisional application No. 62/655,968, filed on Apr. 11, 2018.

(51) Int. Cl. G05D 1/10; B64C 39/02; G05D 1/00

(52) U.S. Cl. CPC G05D 1/104; B64C 39/024; G05D 1/0016; B64C 2201/12; B64C 2201/145; B64C 2201/143; B64C 2201/146

(57) ABSTRACT

A computer system for receiving and responding to virtual forces enacted on a drone receives, at a first drone, a second virtual object location. The computer system then determines a first drone operating characteristic associated with the first drone. Further, the computer system calculates a virtual impact strength and virtual impact direction exerted on the first drone based upon the first drone operating. The computer system then communicates one or more control signals to the motors of the first drone to integrate the virtual impact strength and virtual impact direction into a movement of the drone.

### CROSS-REFERENCE TO RELATED APPLICATIONS

This application claims the benefit of and priority to U.S. Provisional Application No. 62/655,968 entitled “VIRTUAL FORCE SYSTEM FOR A DRONE” filed on Apr. 11, 2018, the entire contents of which is incorporated by reference herein in its entirety.

### BACKGROUND

Unmanned aerial vehicles (UAVs) or drones have become increasingly popular in recent times. These drones can be controlled manually or can fly autonomously according to a pre-programmed flight path. Because of these features, drones can be used in a variety of situations from work to recreation. For example, drones may be used to deliver objects from a warehouse to a purchaser's residence. Drones may also be flown for fun, such as in parks or backyards. Increasingly, drones are being flown in competitions, racing through predesigned courses.

Today's drones come with guidance systems that help them to know their location, altitude, and trajectory. Various sensors and radios are used to detect the drone's height, speed, and current position. These sensors may be used to control the drone and to allow for autonomous flight. The ability to fly and control drones with such high levels of precision and agility allows for competitive drone events, such as racing or other objective directed games.

Despite the incorporation of advanced sensors into drones, there is a need for better processing and utilization of the sensor data. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include a computer system for receiving and responding to virtual forces enacted on a drone receives, at a first drone, a second virtual object location. The computer system then determines a first drone operating characteristic associated with the first drone. Further, the computer system calculates a virtual impact strength and virtual impact direction exerted on the first drone based upon the first drone operating. The computer system then communicates one or more control signals to the motors of the first drone to integrate the virtual impact strength and virtual impact direction into a movement of the drone.

Additional disclosed embodiments include a computer system for receiving and responding to virtual forces enacted on a drone. The computer system receives, at a first drone, a second virtual object location. The second virtual object location comprises an indication of a spatial location of a second virtual object. The computer system then determines that a location of the first drone is a threshold distance from the second virtual object location. The computer system also determines a first drone operating characteristic associated with the first drone. The computer system then identifies a second virtual object operating characteristic associated with the second virtual object. Further, the computer system calculates a virtual impact strength and virtual impact direction exerted on the first drone based upon the first drone operating characteristic and the second virtual object operating characteristic. The computer system then communicates one or more control signals to motors of the first drone to integrate the virtual impact strength and virtual impact direction into a movement of the drone.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1 illustrates an embodiment of a drone with its accompanying virtual bubble.

FIG. 2 illustrates an embodiment of a drone with another virtual bubble.

FIG. 3 illustrates an embodiment two drones within colliding virtual bubbles.

FIG. 4 illustrates an embodiment of a drone colliding with a virtual object.

FIG. 5 illustrates an embodiment of a drone with yet another virtual bubble.

FIG. 6 illustrates a flowchart of an example method for receiving and responding to virtual forces enacted on a drone.

### DETAILED DESCRIPTION

Disclosed embodiments include drone systems for receiving and responding to virtual forces enacted on a drone. For example, it may be desirable to play games with multiple user-controlled drones. One of those games may include the ability to shoot virtual projectiles at other drones. Upon being hit by a virtual projectile, disclosed embodiments calculate a physical response to enact upon the drone. For instance, the projectile may cause the drone to suddenly jerk to the side in response to the virtual impact of the projectile. Disclosed embodiments cause the sudden movement to happen without input from the user. As such, a virtual physics response is enacted upon the drone based upon the virtual impact.

Additional or alternate embodiments may receive and respond to virtual forces enacted on a drone where multiple drones are interacting with each other. For instance, a virtual boundary (also referred to as a virtual “bubble”) may surround the drones. When the respective virtual bubbles of the drones come in contact with each other, the drones may enact a virtual physical response on each other. Under such an embodiment, the virtual bubbles around the drones can interact as a form of bumper cars without causing physical damage to the drones that would occur by actual physical contact.

Further, in at least one embodiment, a drone may be associated with attributes that impart on the drone a specified “operating characteristic.” As used herein, the “operating characteristic” describes various virtual physical characteristics associated with the drone, including a virtual mass, virtual size, virtual shape, virtual speed, virtual velocity, and virtual acceleration. In at least one embodiment, the drone may be associated with operating characteristics that are equal to actual real physical characteristics of the drone. Using the operating characteristics, the drone is able to replicate the transfer of momentum that is imparted by an impact with another virtual bubble or virtual object.

In an additional or alternative embodiment, the operating characteristic may be associated with a specific preset template of virtual physical characteristics. For example, in at least one embodiment, a user may be playing a space-based war game. As part of the game, the user may designate his drone as being a space station. Within the game, the space station may be much more massive than a standard fighter. As such, the user's drone may be associate with the operating characteristic of the space station. This operating characteristic may comprise a virtual bubble that has a large radius that matches the radius of the space station within the game. The user's drone may also be associated with a virtual momentum (i.e., a virtual mass of the space station and a current virtual or real velocity) that conforms to the space station within the game. One will appreciate that the game may deal with virtual masses and virtual velocities that are normalized to make game play enjoyable such that the momentum isn't treated as if it were an extremely large value. Collisions between the user's space station and other drones will be calculated as using the user's operating characteristic, which is based upon the space station.

In at least one embodiment, while playing the game described above, one or more users wear augmented-reality headsets. Through the augmented-reality headsets, the users view rendered objects that are in place of each drone. For example, the user may view his drone within an augmented-reality environment that depicts the drone as if it were in physical appearance a space station. Additionally, the radius of the virtual bubble associated with the drone may match the actual radius of the user's rendered space station. As such, when another virtual object contacts the drone's virtual bubble, it will appear that the object physically hit the rendered space station. A physical force will then be enacted upon the space station causing the user's drone, and in turn the rendered space station, to experience a virtual physical force that causes the user's drone to suddenly move in response to the virtual physical force.

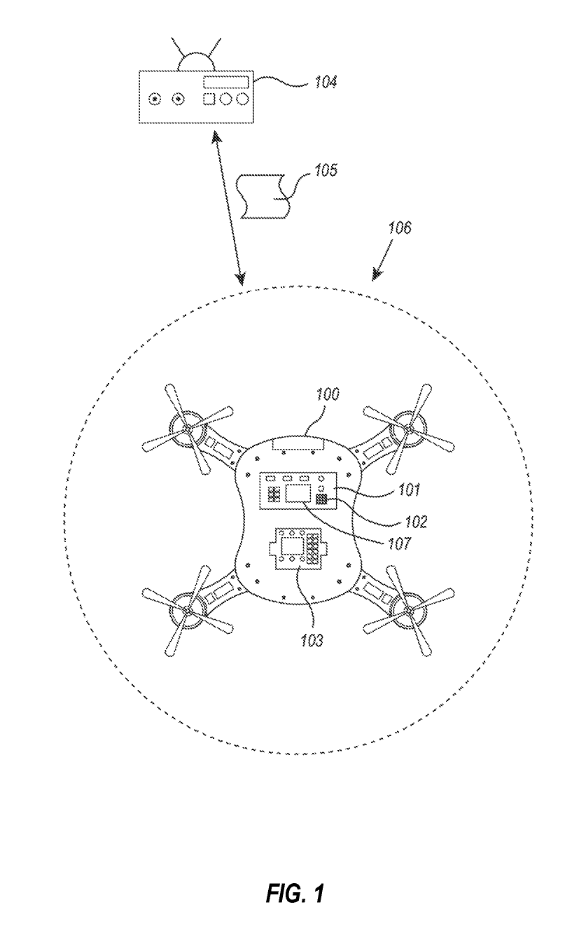

Referring to the figures, FIG. 1 illustrates a drone 100. The term “drone” will be used herein to refer to any type of unmanned aerial vehicle, whether operated manually by a human or automatically by a flight program. The drone 100 includes various hardware and software components that enable it to fly and receive feedback regarding its surroundings. For example, navigational components 102 may be used in conjunction with the processor 101 to determine the drone's current position and calculate its future positions along a flight path. The navigational components 102 may include position-identifying radios including global positioning system (GPS) radios, cellular radios, Wi-Fi radios, Bluetooth radios or other radios configured to receive coordinates from a transmitter. The navigational components may further include an altimeter, a barometer, wind speed sensors, cameras, or other components that are configured to assist in navigating the drone.

The navigational components 102 provide sensor data and other information to processor 101, which interprets that data and uses it to generate control signals for the motor controllers 103. The motor controllers receive these control signals and control the various drone motors accordingly. In this manner, a drone can determine its current location, identify a flight path, and activate the motors accordingly.

The navigational components 102 may also be configured to receive inputs from users via a communication radio 104. The communication radio 104 may comprise a mobile phone, a dedicated remote control, a purpose-built control unit for communicating instructions to one or more drones, or any other device capable of communicating with the drones 100. The communication radio 104 may be configured to send signals to the drone 100, including initiating signal 105. The initiation signal may indicate to the drone that certain calculations are to be performed, including determining a current position and providing power to the motors. Various navigational components may be used to determine the drone's current altitude and heading (if moving), as well as feedback regarding its surroundings (e.g. from camera feed data).

In at least one embodiment, the drone processor 101 is configured to calculate a drone-relative virtual bubble 106. The drone-relative virtual bubble 106 is a three-dimensional area, defined with respect to the spatial location, or coordinates, of the drone 100, that surrounds the drone 100. The drone-relative virtual bubble 106 may be substantially any shape or size, and may vary in shape or size depending on the situation. In at least one simple embodiment, the drone-relative virtual bubble 106 is calculated in the shape of a sphere or a cylinder, with the drone 100 initially being substantially in the center of the sphere or cylinder, although the drone-relative virtual bubble may be calculated such that the drone is not in the center. The drone-relative virtual bubble 106 may specify a volume, relative to the drone, that indicates a virtual boundary for use in enacting virtual physical forces onto the drone and onto other drones.

In at least one embodiment, the drone processor 101 accesses from a local storage device a template for an operating characteristic. For instance, returning to the example provided above, if the drone is representing a space station, the drone processor 101 may access a template for the virtual space station. The template may indicate an operating characteristic of the virtual space station, which in turn is applied to the drone 100. The operating characteristic may comprise a virtual mass of the virtual space station, a virtual velocity of the space station, and/or a spatial description of the virtual bubble that matches the size and shape of the virtual space station.

One will appreciate that due to the growing prevalence of drones, there are many cases when multiple drones may be used within the same general geographic area. In at least one embodiment, a controller unit, in the form of a communication radio 104 is able to communicate information about the drone-relative virtual bubble 106 to at least a portion of the multiple drones that are in the area. The communication may take the form of an initiating signal 105 that comprises a multicast broadcast that is widely dispersed to any listening drone, such that the other drones are aware of the drone-relative virtual bubble 106. In an additional or alternative embodiment, one or more drones selected from the multiple drones are able to communicate without the use of the separate communication radio 104. For example, the drones may communicate through a mesh network. The communication may comprise an indication of at least a portion of the drones' current locations and information about the drones' virtual bubbles. For instance, each virtual bubble may have its own radius and operating momentum.

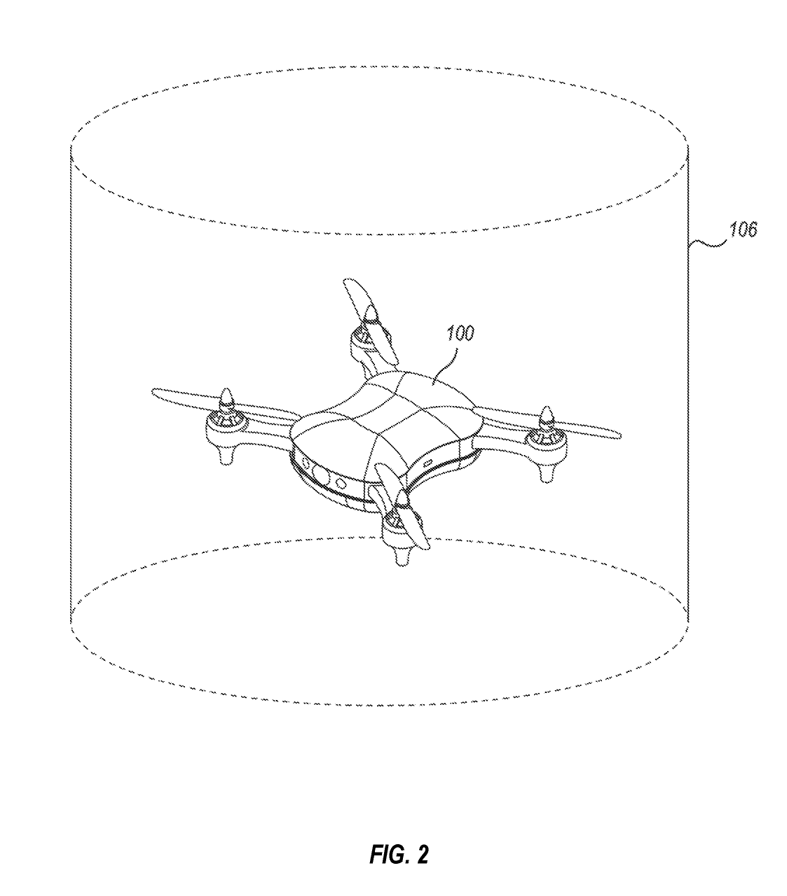

FIG. 2 depicts an embodiment of a virtual bubble 106 surrounding a drone 100. The depicted virtual bubble 106 comprises a cylindrical shape with a specified height and radius. As disclosed above, in various embodiments, the virtual bubble 106 may comprise any number of different shapes and sizes. As explained herein, when the virtual bubble 106 comes into contact with another virtual bubble, the drone 100 will automatically and suddenly move in a way that replicates a virtual physical force being applied between the two different virtual bubbles.

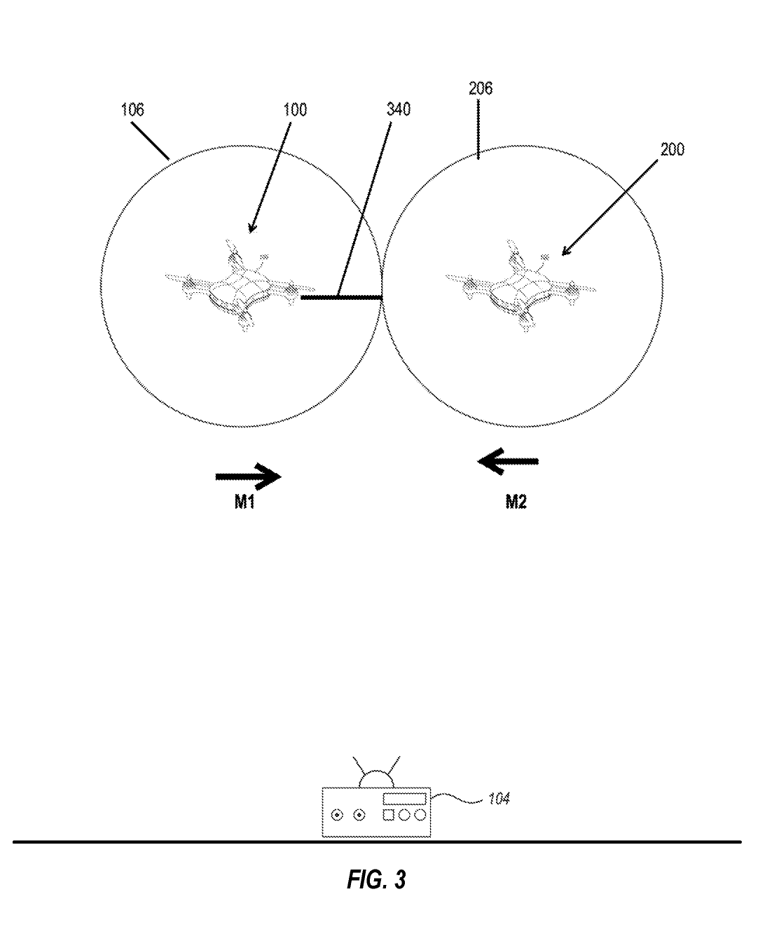

FIG. 3 depicts an embodiment of a first drone 100 and a second drone 200 enacting a virtual physical force on each other. The first drone 100 is associated with a first virtual bubble 106 and the second drone 200 is associated with a second virtual bubble 206. As used herein, the first virtual bubble 106 containing the first drone 100 and the second virtual bubble 206 containing the second drone 200 may each be described as virtual objects. Virtual objects comprise physical and non-physical objects that are associated with virtual physical attributes, such as a virtual mass. In at least one embodiment, the virtual physical attribute may match the real, physical attributes of a drone. Additionally, virtual objects may comprise rendered objects that are rendered in space unassociated to a physical object. The virtual objects may also comprise rendered objects that are rendered over a physical object such has a drone. In at least one embodiment, no rendered object is associated with the drone 100, such that the drone appears in its normal form and other rendered objects appear around the drone 100.

In at least one embodiment, when the virtual bubbles 106, 206 contact each other, a virtual impact strength and virtual impact direction is calculated using conventional vector-based conservation of momentum. For example, Equation 1 and Equation 2 provided below describe the resulting velocities of a one-dimensional transfer of momentum between two objects in an elastic collision:

$$\begin{matrix}{v}_{1} = \frac{{m}_{1} - {m}_{2}}{{m}_{1} + {m}_{2}} {u}_{1} + \frac{2 {m}_{2}}{{m}_{1} + {m}_{2}} {u}_{2} & Equation 1 \\ {v}_{2} = \frac{2 {m}_{2}}{{m}_{1} + {m}_{2 }} {u}_{1} + \frac{{m}_{1} - {m}_{2}}{{m}_{1} + {m}_{2 }} {u}_{2} & Equation 2\end{matrix}$$

Where v₁ is equal to the velocity of object one after the collision, m₁ is equal to the virtual mass defined by the operating characteristic of object one, and u₁ is equal to the velocity of object one before the collision. Similarly, v₂ is equal to the velocity of object two after the collision, m₂ is equal to the virtual mass defined by the operating characteristic of object two, and u₂ is equal to the velocity of object two before the collision.

Using the above equations, a drone processor 101 associated with one or both drones can calculate a resulting velocity and associated direction that would result from the virtual collision. In the depicted embodiment, the physical attribute of momentum of the first drone 100 is visually depicted as M1, and the momentum of the second drone 200 is visually depicted as M2. The drone processor 101 can then purposefully implement maneuvers that reflect the resulting velocity. One will appreciate that the above equations are well-known physics equations. Additionally, one will appreciate that any number of other well-known equations may be used to similar effect, including equations that account for collisions within three-dimensional space and include vector directions with the initial and resulting collisions. As such, conventional momentum equations can be used to calculate the virtual impact strength and the virtual impact direction.

In at least one embodiment, when calculating the resulting effects of a collision, the masses provided by the various operating characteristics may be artificially minimized such that a resulting collision does not cause a massive and potentially hazardous change in flight to the involved drone 100. For instance, the masses may be set such that an impact causes the drones to shake and adjust velocity within a threshold magnitude in order to prevent the drone 100 from losing control and crashing.

As depicted in FIG. 2, the virtual bubbles 106, 206 are in contact with each other. In at least one embodiment, the virtual bubbles 106, 206 are defined with respect to one or more threshold distances from the drone 100, 200. As such, when it is detected that an edge of another virtual bubble 206 is within a threshold distance 340 from the drone 100, it is determined that the two virtual bubbles 106, 206 have collided. In at least one embodiment, the virtual bubble 106 is defined by a set of threshold distances that extend in different directions, at different angles, and at different distances from the drone 100 in order to define a virtual bubble shape and size.

In at least one embodiment, a collision between virtual bubbles 106, 206 is detected by processors embedded within the drones 100, 200 themselves. In contrast, in at least one embodiment, the collision is detected by one or more processors embedded within a communication radio 104 and then communicated to the drones 100, 200. Additionally, in at least one embodiment, the locations of each drone 100, 200 is tracked and updated using a system of different sensors. For example, each drone may use a combination of GPS antennas, WIFI triangulation, vision tracking systems, and other similar conventional location tracking means to identify their own location as accurately as feasible. Additional external sensors, such as cameras may also track the location of the one or more drones and provide the information. For instance, when being used with augmented reality systems, the augmented reality system may also comprise a camera that tracks the location of one or more drones and feeds the tracking information to the drones.

Further, in at least one embodiment, one or more drones 100, 200 may be designated as controller drones. The controller drones may track and communicate the data relating to the other drones that are flying. Further in at least one embodiment, as one or more drones 100, 200 come within a threshold distance to each other, the drones 100, 200 may communicate directly with each other through a second channel, such as Bluetooth in order to maximize communication throughout and ensure that each drone 100, 200 is constantly updated regarding the location of other nearby drones.

As the drones 100, 200 fly, the drones 100, 200 and/or a communication radio 104 constantly communicate the drones' current locations, velocities (including headings), and virtual bubble parameters (also referred to herein as operating characteristics). In at least one embodiment, the various locations of virtual objects (including drones) and their operating characteristics are received in the same communication. In contrast, in at least one embodiment, it may only be necessary for the drones 100, 200 to communicate their respective virtual bubble parameters a single time. For example, in at least one embodiment, during an initiating signal 105, each drone may communicate or receive its desired operating characteristics. The operating characteristics may be communicated from the communication radio 104 from each drone individually to each other, through a mesh-network, through a multicast communication, or through any other means.

Further, in at least one embodiment, the drones 100, 200 may be initializing themselves into a common game or software scheme. For instance, the drones 100, 200 may be preparing to play the above reference space-based war game. The game itself may comprise templates for pre-determined characters and associated operating characteristics for each character. The templates may be pre-loaded into the memory of each drone 100, 200. As such, in at least one embodiment, if each drone 100, 200 is accessing the same base software, it may only be necessary to send a simple identifier relating each drone 100, 200 to a particular stored template. The drones 100, 200 can then look-up the identifier and gather the necessary operating characteristic data without needing to actually broadcast the operating characteristic data itself.

Once the operating characteristic data has been communicated, the drones 100, 200 and/or the communication radio 104 may communicate only the current locations and/or velocity of each drone 100, 200. The virtual bubble parameters can then be overlaid onto the drone's locations and velocities. In at least one embodiment, the communicated drone locations comprise GPS coordinates and/or data gathered from each drone's respective inertial measurement unit (IMU). Further, in at least one embodiment, the drone's location is calculated by the drone based upon data received from the variety of sensors mentioned above.

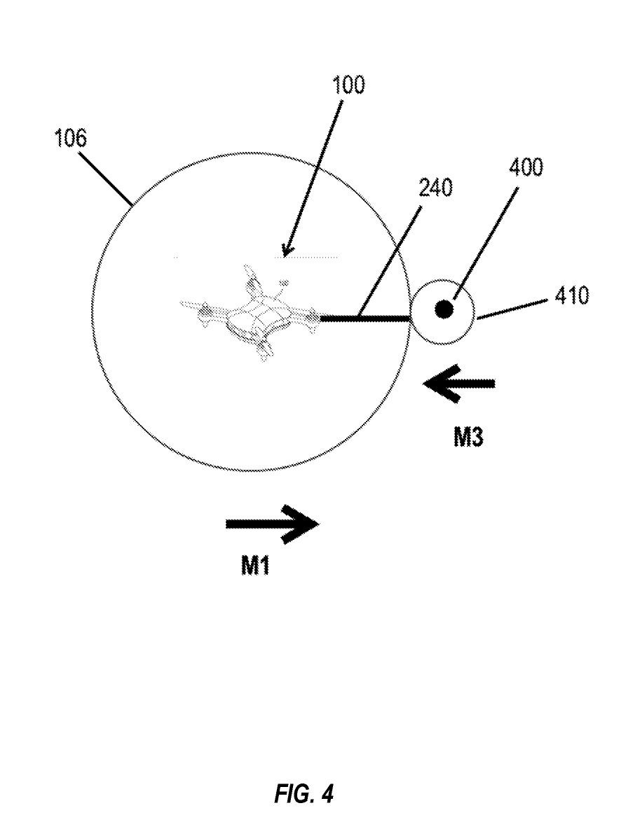

FIG. 4 depicts an embodiment of a first drone 100 and a virtual object 400 preparing to enact a virtual physical force on each other. The first drone 100 is associated with a first virtual bubble 106 and the virtual object 400 is associated with a second virtual bubble 410. The momentum of the first drone 100 is visually depicted as M1, and the momentum of the virtual object is visually depicted as M3. In at least one embodiment, the virtual object comprises a virtual projectile shot by another drone at the first drone 100. In at least one embodiment, the virtual object comprises the same radius as the virtual bubble 410. When the virtual bubble 410 contacts the virtual bubble 106, the two virtual bubbles 410, 106 will impart virtual forces on each other. In at least one embodiment, the virtual object 400 disappears, or virtually explodes, upon contact with the virtual bubble 106. As such, a user viewing the scene through an augmented-reality headset would viewing the projectile hit and explode against the virtual representation of the drone 100.

In response to the virtual impact, the drone 100 automatically communicates motor control signals to the drone's motors that create the movement responsive to the virtual force enacted by the virtual projectile. The communicated motor control signals may take priority and override motor controls being provided by a user or by an autopilot operating on the drone 100. For example, the drone 100 may calculate that the virtual projectile imparted a particular momentum onto the drone 100. Using Newtonian physics, the drone 100 may calculate a responsive change in the momentum of the drone and communicate that change to the drone's motors. Additionally, in at least one embodiment, the drone 100 may communicate a haptic feedback response to a controller being used by the user. As such, the user may feel the controller vibrate in response to the impact. Due to the responsive movement of the drone 100, a user viewing the scene through an augmented-reality headset would see the virtual representation of the drone 100 also move in reaction to the impact of the projectile.

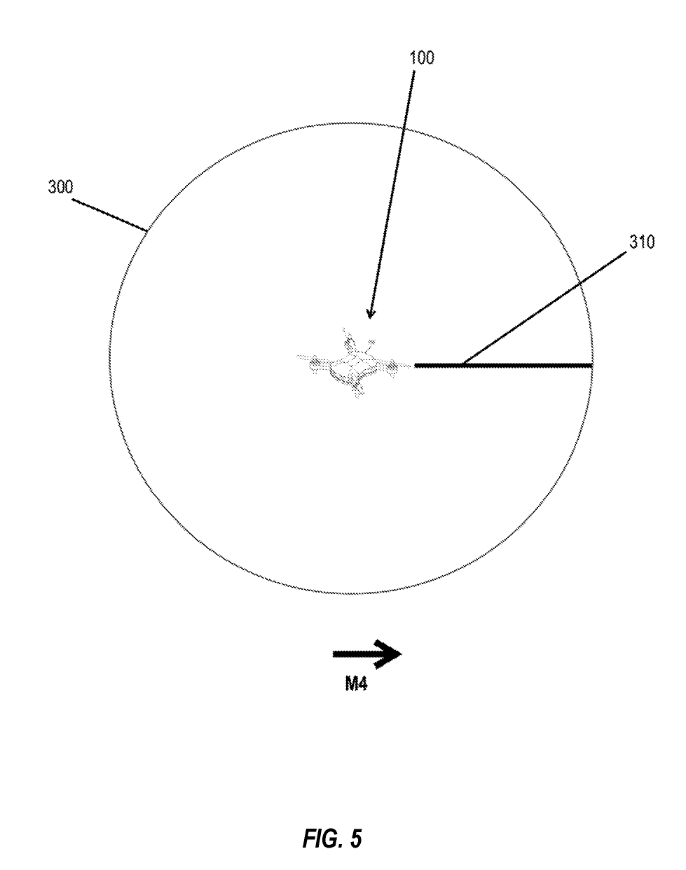

FIG. 5 depicts an embodiment of the drone 100 surrounded by a virtual bubble 300 that comprises a larger threshold distance 310 than the previously depicted virtual bubbles 106, 206, 410. In at least one embodiment, the threshold distance may be defined manually by a user. The virtual bubble 300 may also be associated with a heavier virtual mass. As such, the momentum, indicated as M4, may reflect the heavier virtual mass now associated with the virtual bubble 300. Though the virtual bubbles 300 of the present disclosure have been presented as simple shapes, such as globes or cylinders, in at least one embodiment, the virtual bubbles 300 may comprise any number of different complex shapes and sizes. For example, a virtual bubble 300 may be sized and shaped to exactly fit the dimensions of a star fighters, a bi-plane, or any number of other objects.

In at least one embodiment, the threshold distance that defines the virtual bubble may be dynamically defined. For example, as the operating characteristic of a second virtual object in the area dictate a potential higher strength virtual impact, the threshold distance may increase. Increasing the threshold distance in this may assure that if an impact happens, there is sufficient time for a user to safely react and control the drone 100.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

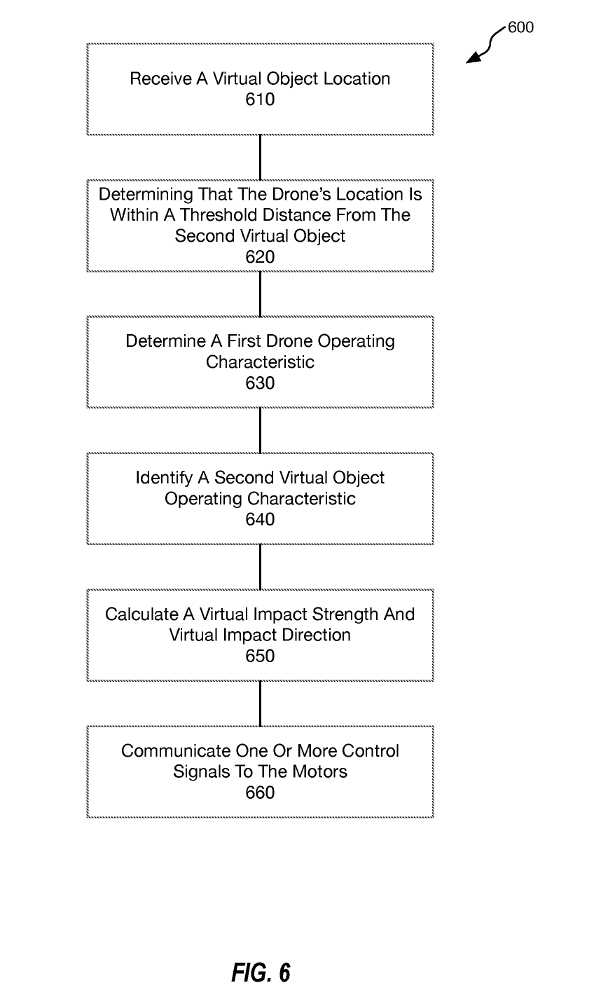

In view of the systems and architectures described above, methodologies that may be implemented in accordance with the disclosed subject matter will be better appreciated with reference to the flow chart of FIG. 6. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 depicts that a method 600 for receiving and responding to virtual forces enacted on a drone includes an act 610 of receiving a virtual object location. Act 610 comprises receiving, at a first drone, a second virtual object location, wherein the second virtual object location comprises an indication of a spatial location of a second virtual object. For example, as explained and depicted with respect to FIG. 3, a communication radio 104 can communicate to a first drone 100 the location of a second drone 200. The communicated location may comprise the GPS coordinates of the second drone 200 and/or a relative location of the second drone 200 with respect to the first drone 100.

FIG. 6 also shows that the method 600 includes an act 620 of determining that the drone's location is within a threshold distance from the second virtual object. Act 620 comprises determining that a location of the first drone is a threshold distance from the second virtual object location. For example, as depicted and described with respect FIG. 3, the first drone 100 is associated with the virtual bubble 106 that comprises a particular radius 340. The first drone detects when the second virtual object (e.g., the second 200) is within a threshold distance of the first drone 100. In at least one embodiment, the threshold distance comprises the sum of the radius 340 of the first virtual bubble 106 plus the radius of the second virtual bubble 206. In contrast, in at least one embodiment, the threshold distance is calculated based an interaction of a three-dimensional mapping, based upon multiple threshold distances, of the first virtual bubble 106 with a three-dimensional mapping of the second virtual bubble 206.

FIG. 6 further shows that the method 600 includes an act 630 of determining the drone's operating characteristic. Act 630 comprises determining a first drone operating characteristic. For example, as depicted and described with respect to FIG. 3, the first drone 100 and virtual bubble 106 are associated with a particular momentum, M1. The momentum, M1, is calculated based upon a virtual mass associated with the first drone 100. The virtual mass may be determined automatically by the first drone 100 or may be provided directly or indirectly by a user. For instance, the user may activate a game that causes the first drone 100 to play the part of a B-2 bomber. The game may have a pre-programmed template that describes a virtual mass associated with the B-2 bomber character. The first drone 100 then calculates its momentum based upon the virtual mass and the current velocity of the drone 100. In at least one embodiment, one or more multiplicative factors may be applied to the virtual mass and/or drone velocity in order to normalize the result “operating momentum.”

In addition, FIG. 6 shows that the method 600 includes an act 640 of identifying a second virtual object operating characteristic. Act 640 comprises identify a second virtual object operating characteristic associated with the second virtual object. For example, as depicted and described with respect to FIG. 3, the communication radio 104 communicates to the first drone an operating characteristic associated with the second drone 200.

Further, FIG. 6 shows that the method 600 includes an act 650 of calculating a virtual impact strength and virtual impact direction exerted on the drone. Act 650 comprises calculating a virtual impact strength and virtual impact direction exerted on the first drone based upon the first drone operating characteristic and the second virtual object operating characteristic. For example, as depicted and described with respect to FIG. 3, the first drone 100 receives the operating characteristic from the second drone 200. The first drone 100 is then able to calculate, using simple Newtonian physics the resulting virtual impact strength and virtual impact direction enacted upon the first drone 100 by the collision with the second drone 200.

Further still, FIG. 6 shows that the method 600 includes an act 660 of communicating one or more control signals to the motors. Act 660 comprises communicating one or more control signals to the motors of the first drone to integrate the virtual impact strength and virtual impact direction into a movement of the drone. For example, as depicted and described with respect to FIG. 3, the first drone 100 can then communicate, to its motor controllers, control signals that cause the first drone to suddenly react to the virtual physics imparted by the collision with the virtual objects (e.g., the second drone 200).

One will appreciate that the embodiment disclosed herein provide a system for enacting physical responses to a drone without damaging the drone's hardware. Such disclosed embodiments provide platforms for building games, training programs, and other previously unavailable system for drones.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for receiving and responding to virtual forces enacted on a drone, comprising:
one or more processors; and
one or more computer-readable media having stored thereon executable instructions that when executed by the one or more processors configure the computer system to perform at least the following:
receive, at a first drone, a second virtual object location, wherein the second virtual object location comprises an indication of a spatial location of a second virtual object;
determine that a location of the first drone is a threshold distance from the second virtual object location;
determine a first drone operating characteristic associated with the first drone;
identify a second virtual object operating characteristic associated with the second virtual object;
calculate a virtual impact strength and virtual impact direction exerted on the first drone based upon the first drone operating characteristic and the second virtual object operating characteristic; and
communicate one or more control signals to motors of the first drone to integrate the virtual impact strength and virtual impact direction into a movement of the first drone.

2. The computer system of claim 1, wherein at least one processor selected from the one or more processors is integrated within the first drone.

3. The computer system of claim 2, wherein at least another processor selected from the one or more processors is integrated within a second drone.

4. The computer system of claim 1, wherein at least one processor selected from the one or more processors is integrated within a purpose-built control unit that is not attached to a drone.

5. The computer system of claim 1, wherein the location of the first drone is calculated based upon data received from a global positioning system radio integrated within the first drone.

6. The computer system of claim 1, wherein the location of the first drone comprises a location relative to one or more other objects and the location of the first drone is calculated based upon data received from a camera integrated within the first drone.

7. The computer system of claim 1, wherein the threshold distance is user defined.

8. The computer system of claim 1, wherein the threshold distance is associated with the second virtual object operating characteristic.

9. The computer system of claim 1, wherein the second virtual object location is received in the same communication as the second virtual object operating characteristic.

10. The computer system of claim 1, wherein the second virtual object comprises a second drone.

11. The computer system of claim 1, wherein the second virtual object comprises a second rendered object within an augmented reality environment that includes a first rendered object representing the first drone.

12. The computer system of claim 11, wherein the second rendered object within the augmented reality environment comprises a rendering of a projectile traveling towards the first rendered object.

13. The computer system of claim 1, wherein no rendered object is associated with the first drone.

14. A computer-implemented method for receiving and responding to virtual forces enacted on a drone, comprising:
receiving, at a first drone, a second virtual object location, wherein the second virtual object location comprises an indication of a spatial location of a second virtual object;
determining that a location of the first drone is a threshold distance from the second virtual object location;
determining a first drone operating characteristic associated with the first drone;
identifying a second virtual object operating characteristic associated with the second virtual object;
calculating a virtual impact strength and virtual impact direction exerted on the first drone based upon the first drone operating characteristic and the second virtual object operating characteristic; and
communicating one or more control signals to motors of the first drone to integrate the virtual impact strength and virtual impact direction into a movement of the first drone.

15. The method of claim 14, wherein the threshold distance is associated with the second virtual object operating characteristic.

16. The method of claim 14, wherein the second virtual object comprises a second drone.

17. The method of claim 14, wherein the second virtual object comprises a second rendered object within an augmented reality environment that includes a first rendered object representing the first drone.

18. The method of claim 17, wherein the second rendered object within the augmented reality environment comprises a rendering of a projectile traveling towards the first rendered object.

19. The method of claim 14, wherein no rendered object is associated with the first drone.

20. A computer implemented method for receiving and responding to virtual forces enacted on a drone, comprising:
receiving, at a first drone, a second drone location, wherein the second drone location comprises an indication of a spatial location of a second drone;
determining a first drone operating characteristic associated with the first drone;
calculating a virtual impact strength and virtual impact direction exerted on the first drone based upon the first drone operating characteristic; and
communicating one or more control signals to motors of the first drone to integrate the virtual impact strength and virtual impact direction into a movement of the first drone.
